(19) United States
(12) Patent Application Publication
(10) Pub. No.: US 2026/0128634 A1
(43) Pub. Date: May 7, 2026

(54) ELECTRIC MOTOR DRIVE AND ENCLOSURE FOR AN ELECTRIC MOTOR DRIVE

(71) Applicant: Danfoss Power Electronics A/S, Grästen (DK)

(72) Inventor: Anders LORENZEN, Grästen (DK)

(21) Appl. No.: 19/366,721

(22) Filed: Oct. 23, 2025

(30) Foreign Application Priority Data
Nov. 6, 2024 (DE) 102024132402.3

(51) Int. Cl. H02K 5/04; H02K 9/00

(52) U.S. Cl. CPC H02K 5/04; H02K 9/00

(57) ABSTRACT

The present invention pertains to an electric motor drive including a housing with a cooling portion and a cable connection portion, a connection frame connected to the housing and a cover for covering the cable connection portion. According to the invention, the cover is connected to the housing and the frame for at least partially covering the cable connection portion. The invention is also directed at an enclosure for an electric motor drive.

### CROSS-REFERENCE TO RELATED APPLICATION

This application claims foreign priority benefits under 35 U.S.C. § 119 from German Patent Application No. 102024132402.3, filed Nov. 6, 2024, the content of which is hereby incorporated by reference in its entirety.

### TECHNICAL FIELD

The present invention pertains to an electric motor drive comprising a housing with a cooling portion and a cable connection portion, a connection frame connected to the housing and a cover for covering the cable connection portion. According to the invention, the cover is connected to the housing and the frame for at least partially covering the cable connection portion. The invention is also directed at an enclosure for an electric motor drive.

### BACKGROUND

Electric motor drives may be installed in environments which may be hazardous to the safe operation of the drive. During installation of the drive, portions of the drive may have to be opened such that the drive is exposed to risks such as moisture and/or dirt entering the drive. Special precautions may have to be taken to avoid these risks, thereby complicating the installation of the drive.

### SUMMARY

The aim of the present invention is to overcome this problem by providing an improved electric motor drive which maintains a high IP class even when the drive is installed in hazardous environments. This aim is achieved by an electric motor drive according to claim 1 and an enclosure for an electric motor drive according to claim 10. Preferable embodiments of the invention are subject to the dependent claims.

According to claim, 1, an electric motor drive is provided, comprising a housing with a cooling portion and a cable connection portion, a connection frame connected to the housing and a cover for covering the cable connection portion. According to the invention, the cover is connected to the housing and the frame for at least partially covering the cable connection portion. The cooling portion may comprise an airduct inlet and/or outlet with cooling fins and preferably a cooling fan. The cover may be arranged such that it covers the cable connection portion against a part of the environment of the drive, which is particularly hazardous or dirty, i.e. the area close to the cooling portion, which is typically exposed to increased airflow with associated dirt and moisture hazards.

In a preferred embodiment of the invention, a cover gasket is provided between the cover and the housing and/or a frame gasket is provided at the frame. The cover gasket further improves the protection of the inside of the drive against the intrusion of external substances into the drive. The cover gasket may be arranged in a plane perpendicular to a plane in which the frame is oriented.

In another preferred embodiment of the invention, the cooling portion and the cable connection portion face in the same direction. The cooling portion and the cable connection portion may comprise openings, which are directed in the same direction. The openings may be provided on the same side of the housing 1.

In another preferred embodiment of the invention, the cooling portion, the cable connection portion and the cover are arranged on the same side of the frame. The frame may comprise a planar structure with a wider outer perimeter than the outer perimeter of the housing. The frame may be provided for connecting the drive to a structure, such as an air duct. The frame may be arranged around the entire housing.

In another preferred embodiment of the invention, a part of the drive's components is arranged opposite the cooling portion with respect to the frame. Most components of the drive may be provided on the same side of the frame as the cooling portion, such that most components of the drive may be positioned within an e.g. air duct accommodating the drive.

In another preferred embodiment of the invention, the cover is screwed and/or snap fitted to the housing and/or the frame. The cover may comprise preferably two holes for screwing in screws, wherein the holes may be oriented perpendicular to a plane of the frame. The frame may comprise two or more corresponding holes, for receiving the screws holding the cover.

In another preferred embodiment of the invention, the outer perimeter of the housing is smaller than the outer perimeter of the frame, in particular the width and length of the housing are smaller than the width and length of the frame. The frame can hence be used to connect the housing to e.g. an air duct wall from the side of the housing and by using e.g. screws.

In another preferred embodiment of the invention, the frame is provided for connecting the electric motor drive to a surface, wherein the cover and the frame are connectable by screws which are oriented in parallel to each other. The surface to which the drive is connected may be a flat surface of an air duct.

In another preferred embodiment of the invention, the cooling portion of the housing is sealed to class IP 55 or higher according to IEC/EN 60 529 and/or the cooling portion of the housing is sealed to class NEMA 12 or higher according to UL50E. The arrangement of the cover facilitates the correct sealing of the drive, especially as the cables connected to the drive are protected by the cover and hence introduce only limited risks to the sealing of the device.

The invention is also directed at an enclosure for an electric motor drive. The enclosure may
comprise any or all of the presently described features associated with the design of the drive.

### BRIEF DESCRIPTION OF THE DRAWINGS

Further details and advantages of the invention are described with reference to the embodiments shown in the figures. The figures show:

FIG. 1: a perspective view of the electric motor drive with the cover removed;

FIG. 2: another perspective view of the electric motor drive including the cover; and

FIG. 3: a partially exploded view of the electric motor drive and its cover.

### DETAILED DESCRIPTION

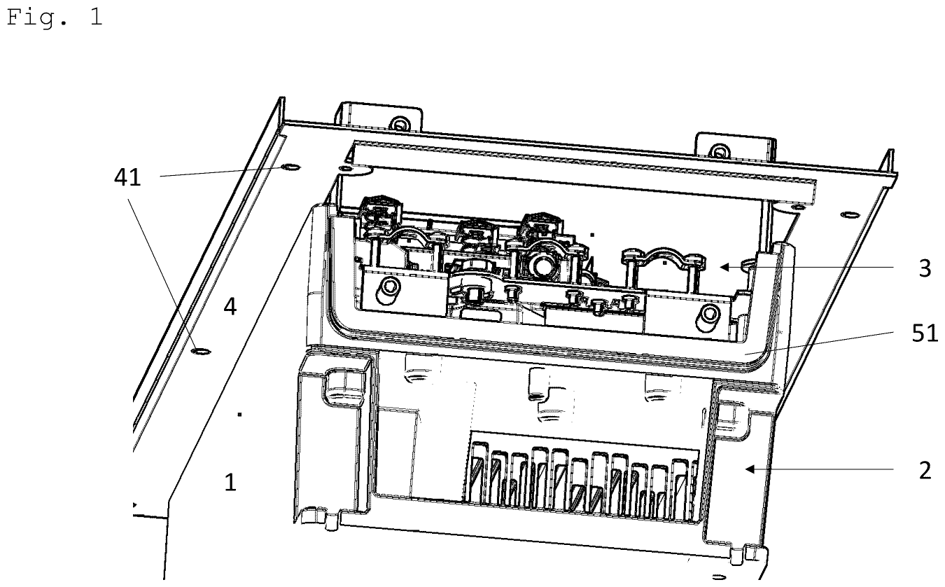

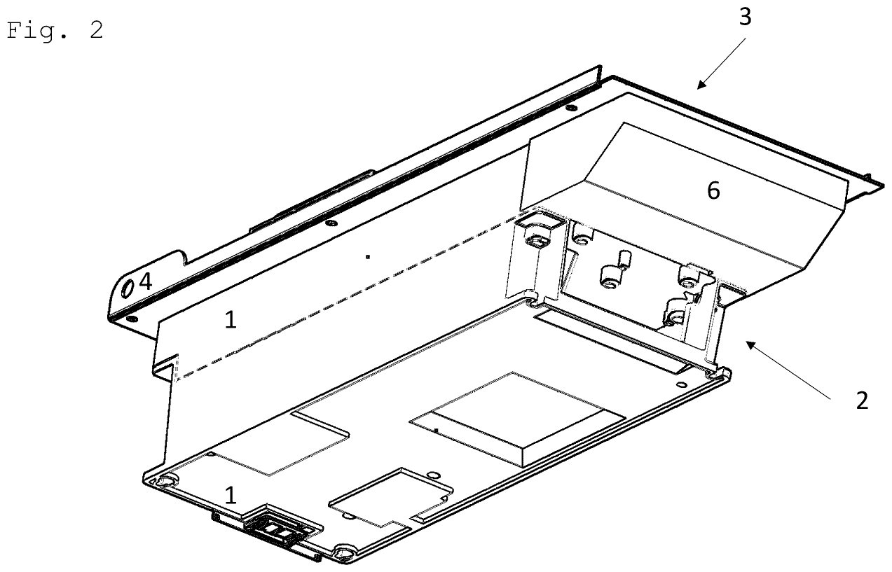

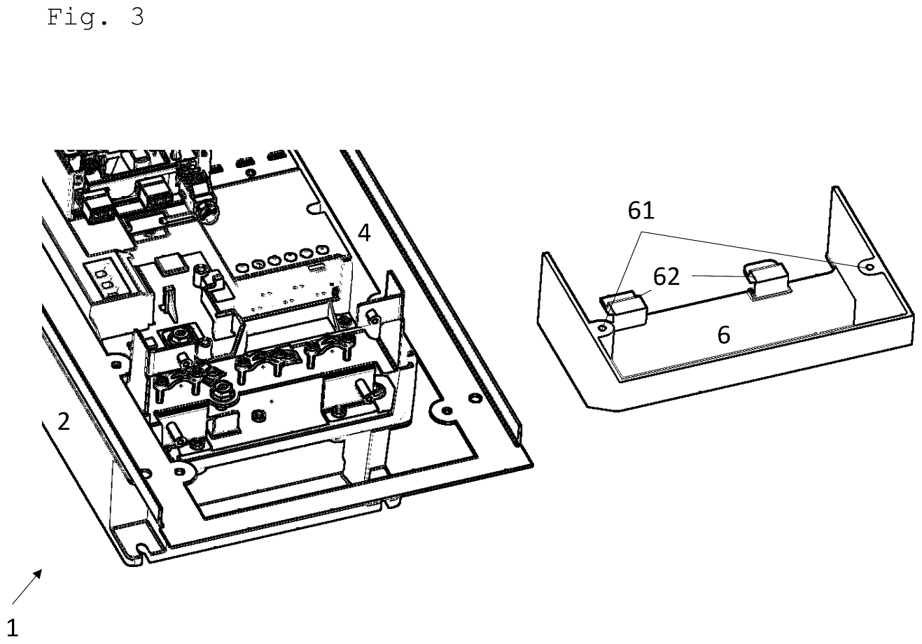

FIG. 1 is a perspective view of the electric motor drive with the cover 6 removed for better clarity. The cover will be shown in FIGS. 2 and 3. The electric motor drive comprises a housing 1 with a cooling portion 2 and a cable connection portion 3. The shape of the housing 1 may approximate a cuboid.

The housing 1 is connected to a connection frame 4 for connecting the housing 1 to an external structure such as a wall not shown in the figures. The cover 6 is provided for at least partially covering the cable connection portion 3. The cable connection portion 3 contains connectors for connecting e.g. power and/or control cables to the drive.

The cooling portion 2 may comprise an airduct inlet and/or outlet with cooling fins and preferably a cooling fan. The cooling portion 2 is shown below the cable connection portion 3. The cable connection portion 3 may be situated between the cooling portion 2 and the frame 4.

The cover 6 may thus be arranged such that it may cover the cable connection portion 3 against a part of the environment of the drive, which is particularly hazardous or dirty, i.e. the area around the cooling portion 2, which is typically exposed to increased airflow with associated dirt and moisture hazards.

A cover gasket 51 is provided at a position between the cover 6 and the housing 1. The cover gasket 51 may be U-shaped with two vertical portions directed towards the frame 4 and/or one horizontal and/or central portion oriented in parallel to the frame 4.

The cover gasket 51 further improves the protection of the inside of the drive against the intrusion of external substances into the drive, once a cover 6 closes the cable connection portion 3 and contacts the cover gasket 51 as shown in FIG. 2. The cover gasket 51 may be arranged in a plane perpendicular or at another angle to a plane in which the frame 4 is oriented. An additional frame gasket may be provided at the frame 4, wherein the frame gasket may be oriented to contact a surface adjacent to the frame 4, such as an air duct wall.

The cooling portion 2 and the cable connection portion 3 may face in the same direction. The cooling portion 2 may be offset with respect to the cable connection portion 3 in the direction the two portions 2, 3 are facing. The cooling portion 2 and the cable connection portion 3 may comprise openings, which are directed in the same direction. The openings may be provided on the same side of the housing 1.

The cooling portion 2, the cable connection portion 3 and the cover 6 are arranged on the same side of the frame 4. The frame 4 may comprise a planar structure with a wider outer perimeter than the outer perimeter of the housing 1. The frame 4 may be provided for connecting the drive to a structure, such as an air duct, which is not shown in the figure but which would typically extend along the upper edge of the frame 4. The frame 4 may comprise through holes 41 for connecting the frame 4 and therefore the drive to a structure adjacent to the drive.

The outer perimeter of the housing 1 is smaller than the outer perimeter of the frame 4. In particular, the width and length of the housing 1 are smaller than the width and length of the frame 4. The frame 4 can hence be used to connect the housing 1 to e.g. an air duct wall from the side of the housing 1 and by using e.g. screws in the through holes 41.

FIG. 2 is another perspective view of the electric motor drive including the cover 6. Here, the cover 6 is shown connected to the housing 1 and the frame 4 and covering the cable connection portion 3, which is hidden behind the cover 6 and only indicated by the arrow of reference number 3.

The cooling portion 2, the cable connection portion 3 and the cover 6 are arranged on the same side of the frame 4. The cover 6 is screwed to the frame 4 and snap fitted to the housing 1.

In the closed state of the drive shown in FIG. 2, the cooling portion 2 of the housing 1 may be sealed to class IP 55 or higher according to IEC/EN 60 529 and/or to class NEMA 12 or higher according to UL50E. The arrangement of the cover 6 facilitates the connection of cables to the cable connection portion 3 and the correct sealing of the drive, especially as the cables connected to the drive are protected by the cover 6 and hence introduce only limited risks to the sealing of the device.

The components shown in FIG. 2, such as the housing 1, the frame 4 and/or the cover 6 may
be comprised by the present invention's enclosure for the electric motor drive. The enclosure
may comprise further of the presently described features of the drive but not the actual electronic components of the drive.

FIG. 3 shows a partially exploded view of the electric motor drive and its cover 6. The cover 6 is shown detached from the housing 1 and the frame 4. A part of the drive's components is arranged opposite the cooling portion 2 with respect to the frame 4. However, most components of the drive may be provided on the same side of the frame 6 as the cooling portion 2, such that most components of the drive may be positioned within an e.g. air duct accommodating the drive. The components of the drive may hence be positioned to allow for efficient cooling of the drive by the air stream in the air duct.

The frame 4 is provided for connecting the electric motor drive to a surface not shown in the figures. The cover 6 and the frame 4 may be connected to each other and/or to an adjacent surface by screws which are oriented in parallel to each other. The surface to which the drive is connected may be a flat surface of an air duct.

The cover 6 may comprise preferably two holes 61 for screwing in screws, wherein the holes may be oriented perpendicular to the plane of the frame 4. The frame 4 may comprise two or more corresponding holes, for receiving the screws holding the cover 6. The cover 6 may be snap fitted to the housing 1 via connection 62 such as snap fit connection.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An electric motor drive comprising a housing with a cooling portion and a cable connection portion, a connection frame connected to the housing and a cover for covering the cable connection portion, wherein the cover is connected to the housing and the frame for at least partially covering the cable connection portion.

2. The electric motor drive according to claim 1, wherein a cover gasket is provided between the cover and the housing and/or that a frame gasket is provided at the frame.

3. The electric motor drive according to claim 1, wherein the cooling portion and the cable connection portion face in the same direction.

4. The electric motor drive according to claim 1, wherein the cooling portion, the cable connection portion and the cover are arranged on the same side of the frame.

5. The electric motor drive according to claim 1, wherein a part of the drive's components is arranged opposite the cooling portion with respect to the frame.

6. The electric motor drive according to claim 1, wherein the cover is screwed and/or snap fitted to the housing and/or the frame.

7. The electric motor drive according to claim 1, wherein the outer perimeter of the housing is smaller than the outer perimeter of the frame, in particular that the width and length of the housing are smaller than the width and length of the frame.

8. The electric motor drive according to claim 1, wherein the frame is provided for connecting the electric motor drive to a surface, wherein the cover and the frame are connected by screws which are oriented in parallel to each other.

9. The electric motor drive according to claim 1, wherein the cooling portion of the housing is sealed to class IP 55 or higher according to IEC/EN 60 529 and/or that the cooling portion of the housing is sealed to class NEMA 12 or higher according to UL50E.

10. An enclosure for an electric motor drive according to claim 1.
